(19) United States
(12) Patent Application Publication
(10) Pub. No.: US 2005/0184049 A1
(43) Pub. Date: Aug. 25, 2005

(54) Manufacturing process method for pneumathode of the inflatable body-heat retaining jacket

(76) Inventors: Horng-Yee Lee, Taipei City (TW); Fu-Hsiang Chang, Jhubei City (TW)

Correspondence Address: Fulltide Enterprise Co., Ltd. & Ameba Co., Ltd., P.O. Box No. 6-57, Junghe, TAIPEI 235, TW

(21) Appl. No.: 10/781,735

(22) Filed: Feb. 20, 2004

(51) Int. Cl. H05B 3/06

(52) U.S. Cl. 219/527; 219/528

(57) ABSTRACT

A manufacturing process method for pneumathode of an inflatable body-heat retaining jacket with layers of a micro-pores PU coating as the base coating and a hydrophilic PU coating as the face coating, which applied upon nylon or polythene fabrics or its interwoven fabrics, and followed by a high frequency welding, to obtain a stable bonded PU coating fabrics, characterized by water vapor permeability, water resistance, and air-tightness. Applying the high frequency welding to the jacket made of PU coating fabrics will generate a pneumathode chamber within layers. Adjustment of thickness thereof can be made by inflating or deflating air through air valves. The body vapor permeates through micro-pores PU coating, thereby reducing uncomfortable sultriness. Vapor thereafter adheres on the breathable PU coating and releases condensation heat to the pneumathode chamber, which also serving for blocking cold air from outside, thereby retaining the body heat.

### BACKGROUND OF THE INVENTION

### FIELD OF THE INVENTION

This invention relates to a manufacturing process method for pneumathode of an inflatable body-heat retaining jacket formed by clothes, sleeves, and a hood, with layers of a micro-pores PU coating as the base coating and a hydrophilic PU coating as the face coating, which applied upon nylon or polythene fabrics or its interwoven fabrics, and followed by a high frequency welding, to obtain a PU coating fabrics with stable bonding effect, which characterized by water vapor permeability, water resistance, and air-tightness. Applying the high frequency welding to the jacket made of the PU coating fabrics will generate a pneumathode chamber within layers, thereby isolating cold air from outside and retaining heat inside.

### SUMMARY OF THE INVENTION

The invention relates to a manufacturing process method for pneumathode of an inflatable body-heat retaining jacket formed by clothes, sleeves, and a hood, with layers of a micro-pores PU coating as the base coating and a hydrophilic PU coating as the face coating, which applied upon nylon or polythene fabrics or its interwoven fabrics, and followed by a high frequency welding, to obtain a PU coating fabrics with stable bonding, characterized by water vapor permeability, water resistance, and air-tightness. Applying the high frequency welding to the jacket made of PU coating fabrics will generate a pneumathode chamber within layers. Adjustment of thickness thereof can be made by inflating or deflating air through an air valve, wherethrough air is blown in or deflated. The body vapor permeates through micro-pores PU coating, thereby reducing uncomfortable sultriness. Vapor thereafter adheres on the breathable PU coating and releases condensation heat in the pneumathode chamber, which also serving for blocking cold air from outside, thereby retaining body temperature. As such, the present invention preserves heat inside and allow body heat vapor to release.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows the perspective view of the present invention.

FIG. 2 shows an exploded elevational view of the present invention.

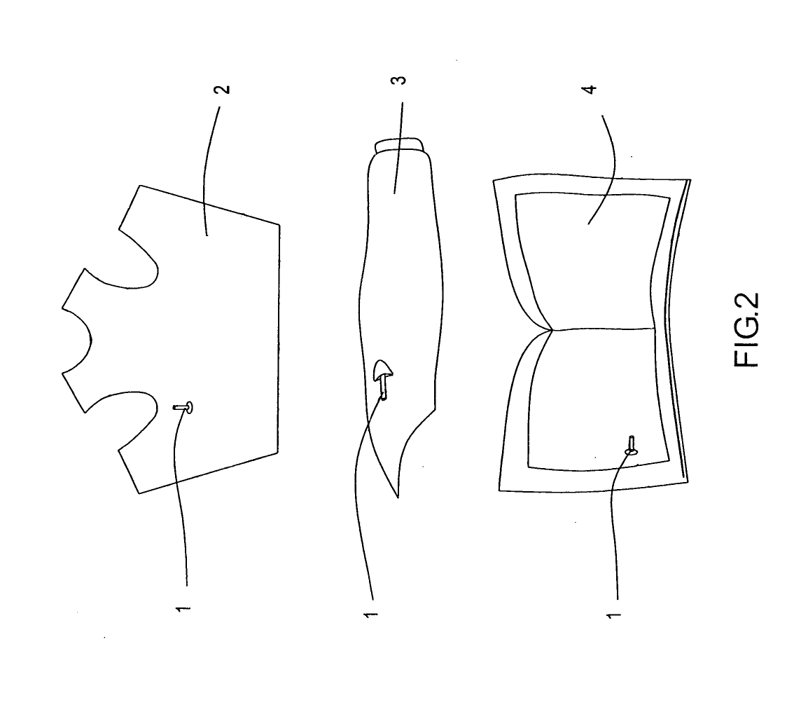

FIG. 3 shows a functional representation of the present invention.

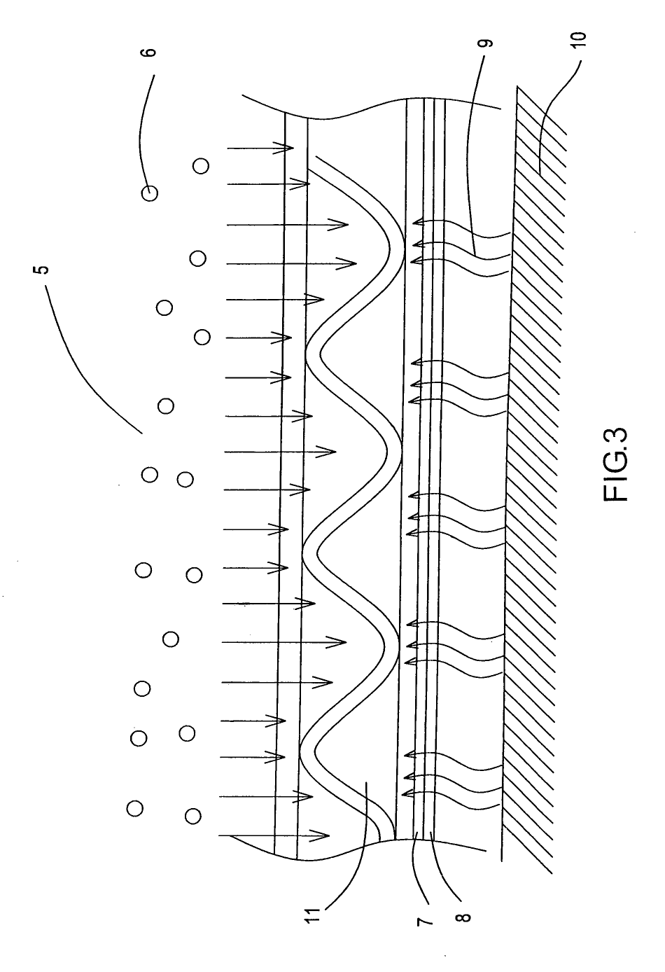

### DETAILED DESCRIPTION OF THE PREFERRED EMBODIMENTS

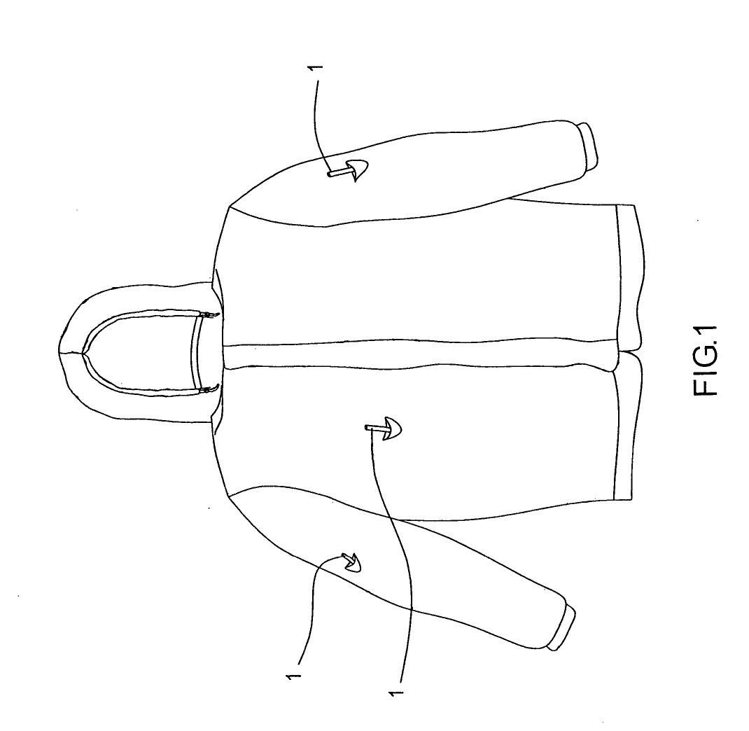

With reference to the FIGS. 1˜3, the present invention includes a clothes, sleeves, and a hood, wherein

The clothes 2, sleeves 3, and hood 4 are formed with layers of a micro-pores PU 7 and a hydrophilic PU coating 8 as the base and face coating, respectively, which applied upon nylon or polythene fabrics or its interwoven fabrics, and followed by a high frequency welding, to obtain a stable bonded PU coating fabrics. The PU coating fabrics is soft hand feeling, with good quality in respect of water vapor permeability, water resistance, water-solubility resistance, and air tightness. Between layers of the PU coating fabrics thereby form a pneumathode chamber. Adjustment of thickness thereof can be made by inflating through an air valve 1 to a pneumathode chamber 11. Vapor 9, emitting from human body 10, penetrates through micro-pores PU coating 7 and absorbed by hydrophilic PU coating 8, thereby lowering body's uncomfortable sultriness. The body vapor 9 thereafter adheres on the hydrophilic PU coating 8 and releases condensation heat to the pneumathode chamber 11, which also servicing for blocking cold air 6 from outside environment 5, thereby retaining the body heat. In summary, the present invention is both water vapor permeable and heat retainable.

When in cold environment, by blowing air through air valves at clothes, sleeves, and the hood, the pneumathode chamber of the jacket can be inflated, thereby lowering air induction and convection and absorbing the heat vapor emitting from the body. While in warmer environment, air in pneumathode chamber can be released from valves at clothes, sleeves, and hood.

To reveal in more detail in present invention's advancement and practicality, a summary is given below,

1. With the micro-pores coating material, the jacket can be lighter and softer to achieve the same bonding effect.

2. Body vapor permeates through the micro-pores PU coating and absorbed by the hydrophilic PU coating, thereby reducing the body's uncomfortable sultriness.

3. Vapor adheres on the hydrophilic PU coating and releases condensation heat in the pneumathode chamber, which also serving for blocking cold air from outside, thereby retaining the body-heat.

4. Advancement and practicality.

5. Enhancing industry competitiveness.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A manufacturing process method for pneumathode of an inflatable body-heat retaining jacket with nylon or polythene fabrics or its interwoven fabrics as a basic material to be processed with steps of:
(1) applying with layers of a micro-pores PU coating as a base coating and a hydrophilic PU coating as a face coating thereon;
(2) following by a high frequency welding, thereby obtaining a stable bonded PU coating fabrics characterized by water vapor permeability, water resistance, and air-tightness.
